(19) United States
(12) Patent Application Publication
(10) Pub. No.: US 2015/0293276 A1
(43) Pub. Date: Oct. 15, 2015

(54) MIRROR FOR CHECKING BLIND SPOT

(71) Applicant: Komy Co., Ltd., Kawaguchi-shi (JP)

(72) Inventors: Tetsuo Yokota, Kawaguchi-shi (JP); Yoshiyuki Iwata, Kawaguchi-shi (JP); Hisanaga Takeda, Kawaguchi-shi (JP); Yoshinori Koyama, Kawaguchi-shi (JP); Masaki Shinozaki, Kawaguchi-shi (JP)

(21) Appl. No.: 14/438,130

(22) PCT Filed: May 10, 2013
(86) PCT No.: PCT/JP2013/063203

§ 371 Date: Apr. 23, 2015

(30) Foreign Application Priority Data
Oct. 24, 2012 (JP) 2012-235190

(51) Int. Cl. G02B 5/10; B60R 1/08

(52) U.S. Cl. CPC G02B 5/10; B60R 1/081

(57) ABSTRACT

A mirror, when attached along a curved surface, facilitates recognition of an image in a blind spot by reducing a feeling of strangeness caused by the aspect ratio of the image. Many linearly-extending strip reflective surfaces 5a are arranged on a surface of a sheet 2 to be parallel and adjacent to one another. An inclination angle A formed between a width direction of each of the strip reflective surfaces 5a and a surface direction of the sheet 2 is sequentially changed with an increase in a distance in a direction transverse to an extension direction of the strip reflective surfaces 5a. An aggregate of the strip reflective surfaces 5a has a cylindrical convex mirror function, and the mirror 1 is bendable in a cylindrical shape about an axis parallel to the direction transverse to the extension direction of the strip reflective surfaces 5a.

### TECHNICAL FIELD

The present invention relates to a mirror for checking a blind spot, and more specifically to a mirror for checking a blind spot which, when attached to a curved surface of a column or the like, can be attached along the curved surface and facilitate recognition of an image of a blind spot by reducing feeling of strangeness in the aspect ratio of the image as much as possible.

### BACKGROUND ART

A convex mirror and a planar Fresnel mirror are known as mirrors for preventing collision. Since the convex mirror protrudes greatly from an attachment surface with a fitting therebetween, the convex mirror is attached at a high position so as not to interfere with traffic. Accordingly, the convex mirror has a problem that people with low eye levels such as short people and people on wheelchairs tend to miss the mirror.

Since the planar Fresnel mirror is attached planarly along an attachment surface, the Fresnel mirror hardly protrudes and does not have the problem described above (see Patent Document 1). However, in a case where the Fresnel mirror is attached to a curved surface of a column or the like, the entire surface of the planar Fresnel mirror is not attached to the curved surface but most of the surface of the Fresnel mirror is spaced away from the curved surface, and this spaced-away portion interferes with traffic. This problem can be solved by making the Fresnel mirror flexible and curve along the curved surface such that the entire surface of the mirror is attached to the curved surface. However, since the conventional Fresnel mirror has a spherical convex mirror function, this convex mirror function is further increased and an image is distorted to be greatly stretched in a circumferential direction of the curved surface, when the mirror is bent along the curved surface. In other words, the conventional Fresnel mirror has a problem that the aspect ratio of the image greatly deviates from 1:1 and recognition of the image becomes difficult.

### PRIOR ART DOCUMENT

### Patent Document

Patent Document 1: Japanese patent application Kokai publication No. 2012-88565

### SUMMARY OF THE INVENTION

### Problem to be Solved by the Invention

An object of the present invention is to provide a mirror for checking a blind spot which, when attached to a curved surface of a column or the like, can be attached along the curved surface and facilitate recognition of an image of a blind spot by reducing feeling of strangeness in the aspect ratio of the image as much as possible.

### Means for Solving the Problem

In a mirror for checking a blind spot of the present invention for achieving the object described above, a large number of linearly-extending strip reflective surfaces are arranged in a surface of a sheet to be parallel and adjacent to one another, an inclination angle formed between a width direction of each of the strip reflective surfaces and a surface direction of the sheet is sequentially changed with an increase in a distance in a direction transverse to an extension direction of the strip reflective surfaces, an aggregate of the strip reflective surfaces has a cylindrical convex mirror function, and the sheet is bendable in a cylindrical shape about an axis parallel to the direction transverse to the extension direction of the strip reflective surfaces.

### Effects of the Invention

In the mirror for checking a blind spot of the present invention, since the sheet in which the many strip reflective surfaces are arranged parallel and adjacent to one another is bendable in a cylindrical shape about the axis parallel to the direction transverse to the extension direction of the strip reflective surfaces, the mirror can be attached while being bent along the curved surface to which the mirror is attached. Accordingly, the mirror does not interfere with traffic.

Moreover, since the inclination angle formed by the width direction of each of the strip reflective surfaces and the surface direction of the sheet is sequentially changed with an increase in the distance in the direction transverse to the extension direction of the strip reflective surfaces and the aggregate of the strip reflective surfaces has the cylindrical convex mirror function, an image of a wide angle can be obtained through the aforementioned convex mirror function, only in the direction transverse to the extension direction of the strip reflective surfaces.

Meanwhile, when the sheet is attached to the curved surface with the extension direction of the strip reflective surfaces being aligned with the circumferential direction of the curved surface of the structure, an image of a wide angle can be obtained in the extension direction of the strip reflection surfaces through a convex mirror function obtained by aligning the extension direction of the strip reflective surfaces with the curved surface of the structure. Since feeling of strangeness in the aspect ratio of the image is reduced by the convex mirror functions respectively in the direction transverse to the extension direction of the strip reflective surfaces and the extension direction, recognition of the image can be facilitated. A situation in the blind spot is thereby made easier to grasp and this is effective in improving the safety.

### BRIEF DESCRIPTION OF THE DRAWINGS

FIG. 1 is a plan view of a mirror for checking a blind spot of the present invention.

FIG. 2 is a cross-sectional view taken along the line A-A in FIG. 1.

FIG. 3 is a cross-sectional view taken along the line B-B in FIG. 1.

FIG. 4 is an enlarge view of a portion in FIG. 3.

FIG. 5 is an explanatory view showing a configuration principle of the mirror of the present invention which has a cylindrical convex mirror function.

FIG. 6 is an explanatory view showing an example of installation of the mirror of the present invention.

FIG. 7 is an explanatory view showing an example of a range of field of view in a direction transverse to an extension direction of strip reflective surfaces in the mirror of the present invention.

FIG. 8 is an explanatory view showing an example of a range of field of view in the extension direction of the strip reflective surfaces in the mirror of the present invention.

FIG. 9 is a plan view showing another example of installation of the mirror of the present invention.

FIG. 10 is a plan view showing examples of regions in a sheet which are used as the mirrors of the present invention.

FIG. 11 is a side view showing yet another example of installation of the mirror of the present invention.

### MODES FOR CARRYING OUT THE INVENTION

A mirror for checking a blind spot of the present invention is described below based on embodiments shown in the drawings.

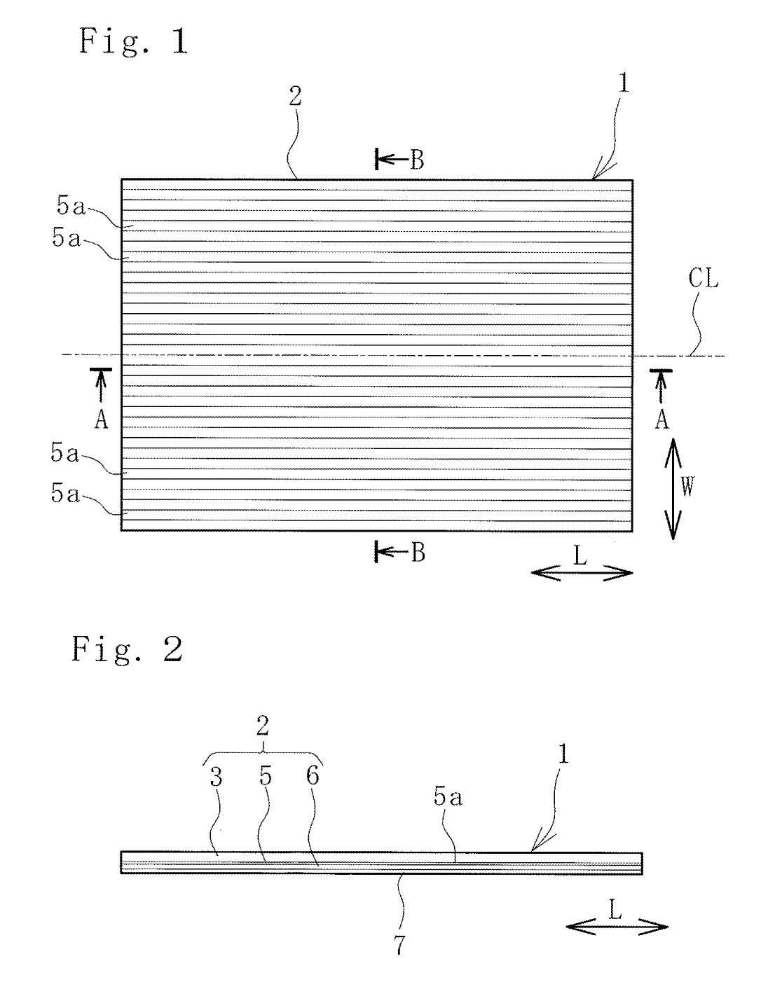

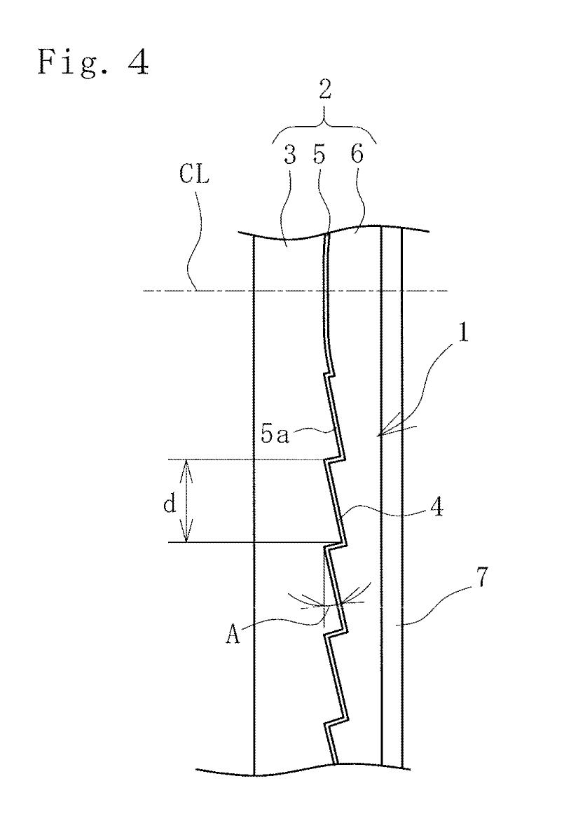

As illustrated in FIGS. 1 to 4, a mirror 1 for checking a blind spot (hereafter, referred to as mirror 1) of the present invention includes a sheet 2 formed by laminating a transparent resin plate 3, a reflective layer 5, and a coating layer 6 to one another. An attachment member 7 for attaching the mirror 1 to a curved surface S of a structure M is provided on a back surface of the sheet 2. Adhering means such as a double-sided adhesive tape and adhesive can be given as examples of the attachment member 7. Screws may be used instead of such adhering means. Alternatively, the adhering means and the screws can be used together. In a case where the attachment member 7 is the adhering means, the adhering means may be provided over the entire back surface of the sheet 2 or only in a periphery thereof. In the case of the screws, the sheet 2 may be screwed at four corners thereof.

Many linearly-extending inclined grooves 4 are formed on a back surface of the planar transparent resin plate 3 to be parallel and adjacent to one another. The reflective layer 5 is laminated on the inclined grooves 4, and the coating layer 6 made of a coating and the like is laminated on the reflective layer 5. The attachment member 7 is attached to a back surface of the coating layer 6. Many strip reflective surfaces 5a are formed by the many inclined grooves 4 and the reflective layer 5. The many strip reflective surfaces 5a extend linearly and are arranged parallel and adjacent to one another in a surface of the sheet 2. In FIGS. 1 to 3, the extension direction of the strip reflective surfaces 5a is shown by the arrow L, and the width direction (direction transverse to the extension direction) of the strip reflective surfaces 5a is shown by the arrow W.

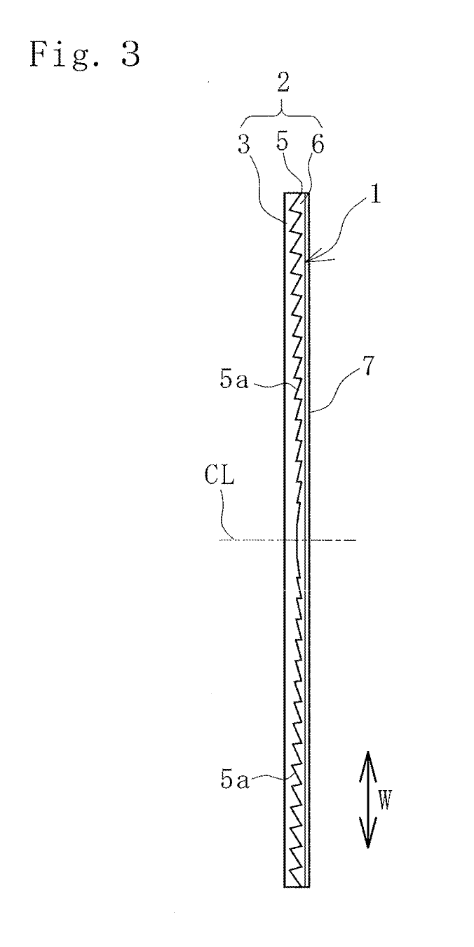

As shown in FIG. 3, in a cross section in the direction (direction of the arrow W) transverse to the extension direction of the strip reflective surfaces 5a, an inclination angle A formed between the width direction of each of the strip reflective surfaces 5a and a face direction of the sheet 2 is set as follows. The inclination angle A of the strip reflective surface 5a located at a center line CL in a sheet center portion is 0°, and the inclination angles A are sequentially increased in a left-right symmetric manner such that the strip reflective surfaces 5a located farther away from the center line CL in directions toward both outer sides have larger inclination angles A. Causing the inclination angles A to sequentially change as described above can cause an aggregate of the many strip reflective surfaces 5a to exert the same reflection function as a convex mirror. Meanwhile, as shown in FIG. 2, in the extension direction (direction of the arrow L) of the strip reflective surfaces 5a, since the strip reflective surfaces 5a extend linearly parallel to the sheet 2, no reflection function of a convex mirror is exerted. In other words, the mirror 1 of the present invention having the configuration described above has the same reflection function as a cylindrical convex mirror, and is an irregular Fresnel mirror having the reflection function of a convex mirror only in the direction of the arrow W transverse to the strip reflective surfaces 5a.

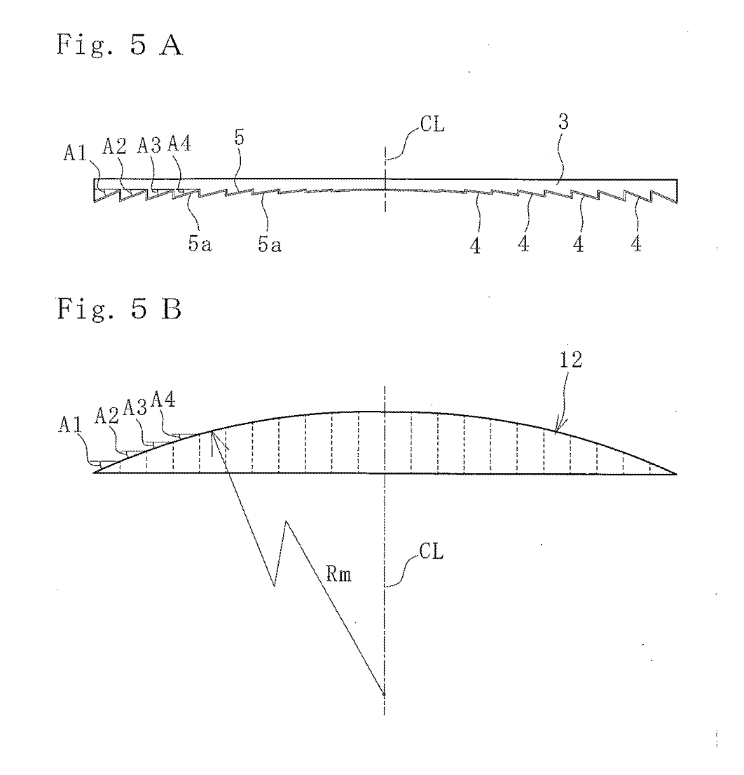

A principle that the mirror 1 of the present invention has a function of a cylindrical convex mirror having a radius of curvature Rm is described by using FIG. 5. FIG. 5(A) is a cross-sectional view showing only the transparent resin plate 3 in the mirror 1, and FIG. 5(B) is a cross-sectional view showing a cylindrical convex mirror along a cross section orthogonal to the cylinder axis. As shown as an example in FIG. 5(B), a cylindrical convex mirror 12 having the radius of curvature Rm is divided in a circumferential direction, into many strip pieces which are planar and have small widths. Then, as shown in FIG. 5(A), the divided strip pieces are planarly rearranged with the inclination angles A1, A2, A3, A4, . . . of the respective strip pieces being maintained as they are. FIG. 5(A) shows a state where the many inclined grooves 4 extending in a far-near direction of the sheet surface are formed on the back surface of the planar transparent resin plate 3 to be parallel and adjacent to one another, and the reflective layer 5 is laminated on the inclined grooves 4. The many strip reflective surfaces 5a extending in the far-near direction of the sheet surface are thereby formed, and the aggregate of these many strip reflective surfaces 5a exerts the function of a cylindrical convex mirror.

The thickness of the sheet 2 forming a main body of the mirror 1 is set in a range of 0.01 mm to 2.0 mm, preferably 0.01 mm to 1.0 mm, more preferably 0.01 mm to 0.8 mm. Particularly, setting the upper limit of the thickness of the sheet 2 to 1.0 mm or less, more preferably 0.8 mm or less can make the mirror 1 flexible. Since the flexible mirror 1 can be bent by hand in attachment work to a column or the like, the attachment work can be facilitated. When the thickness of the sheet 2 is 2.0 mm or close to 2.0 mm, the mirror 1 is not flexible. Thus, it is difficult to bend the mirror 1 by hand and a special bending process needs to be performed before the attachment. The shape of the mirror 1 is preferably a quadrilateral in a plan view as shown as example in FIG. 1. However, various other shapes such as a triangle, a circle, an oval, and a trapezoid can be employed.

The width d of each of the strip reflective surfaces 5a is set in a range of 0.01 mm to 1.0 mm, preferably 0.01 mm to 0.5 mm. The transparent resin plate 3 is made of a polycarbonate resin (PC), an acryl resin (PMMA), a polyethylene resin (PE), a polyethylene terephthalate (PET), or the like.

The reflective layer 5 is formed by laminating an aluminum layer from the transparent resin plate 3 side for example. A metal deposition film, a metal plated film, or the like can be used as the reflective layer 5. The thickness of the reflective layer 5 is about 10 nm to about 200 nm for example.

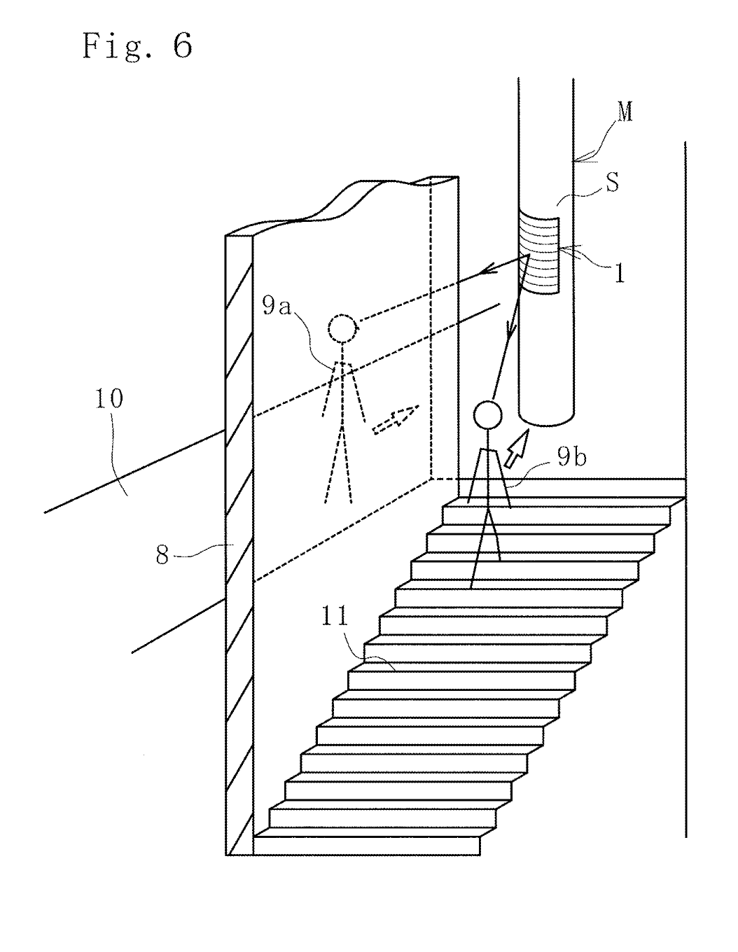

In a region where multiple passages in such a relationship that a blind spot is formed intersect each other, the mirror 1 of the present invention formed of the irregular Fresnel mirror as described above is attached to the structure M such as a column standing in this region as the mirror for checking a blind spot to prevent collision between passers-by. FIG. 6 shows an embodiment in which, in a region where a passage 10 on a platform of a railway station and an upper end of a stairway 11 intersect each other, the mirror 1 of the present invention is attached to a curved surface S of a column M standing in this region. The attachment height of the mirror 1 to the column M is set to be within a range of heights of passers-by 9a, 9b, and the transverse direction (direction of the arrow W) of the strip reflective surfaces 5a is aligned with an up-down direction (axial direction) of the column M. Moreover, the mirror 1 is attached such that the strip reflective surfaces 5a are bent in the extension direction (direction of the arrow L) along the arc-shaped curved surface S of the column M.

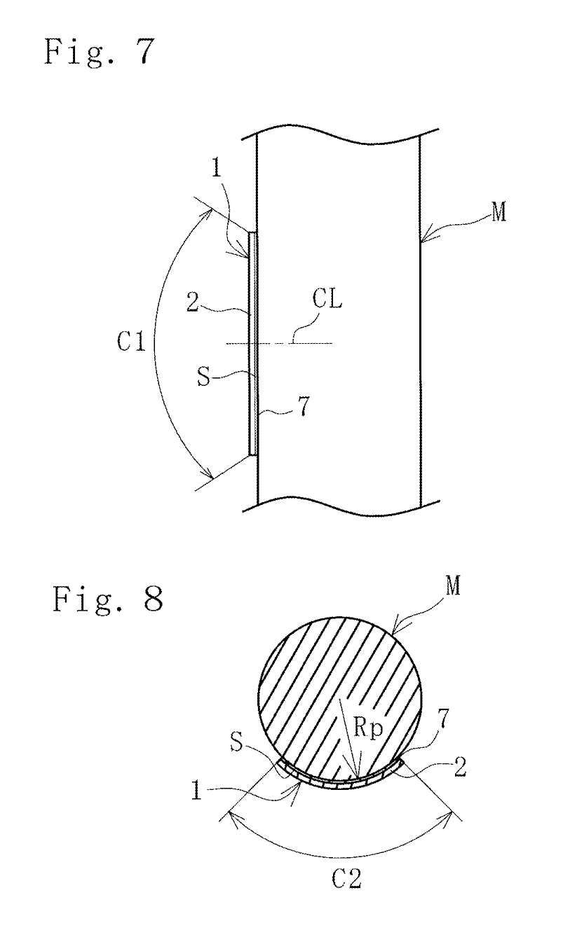

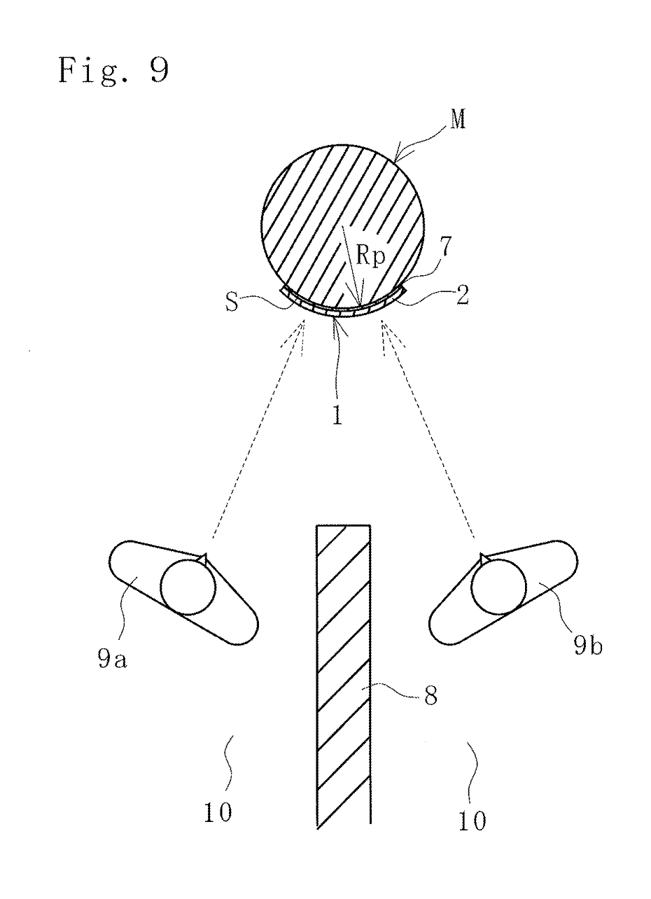

Attaching the mirror 1 of the present invention to the column M as described above allows the passers-by 9a, 9b blind to each other to obtain the following field of view of an image which is visible through the mirror 1. In a vertical direction (up-down direction) of the mirror 1, a field of view C1 of a wide-angle as shown in FIG. 7 can be obtained through the convex mirror function exerted by the mirror 1 only in the transverse direction (direction of the arrow W) of the strip reflective surfaces 5a. Meanwhile, in a horizontal direction (left-right direction) of the mirror 1, a field of view C2 of a wide angle as shown in FIG. 8 can be obtained through a convex mirror function obtained by bending the strip reflective surfaces 5a in the extension direction along the curved surface S of the column M.

The aspect ratio of the image visible in the mirror 1 attached as described above is determined by the radiuses of curvatures which are independently set, in the vertically direction, through the function of the convex mirror having the radius of curvature Rm set by the mirror itself and, in the horizontal direction, through the function of the convex mirror having the radius of curvature Rp set by the column M. Accordingly, feeling of strangeness in the aspect ratio of the image is reduced as much as possible, and recognition of the image is facilitated. Meanwhile, in a conventional Fresnel mirror having a reflection function of a spherical convex mirror, when the mirror is attached to a column in the same way as in the present invention, the radius of curvature Rp of the curved surface S is added to the radius of curvature Rm of the mirror itself in a mirror surface in the circumferential direction of the curved surface S. Accordingly, the conventional Fresnel mirror has a problem that the image is distorted to be greatly stretched in the circumferential direction and recognition of the image becomes difficult.

Moreover, attaching the mirror 1 of the present invention along the curved surface S of a structure such as a column prevents the mirror 1 from protruding in such a way as to become an obstacle of traffic. Accordingly, the mirror 1 can be installed in a range of the heights of passers-by. Hence, it is possible to make the mirror 1 easily visible to short people and people on wheelchairs and thereby improve safety of collision prevention.

FIG. 6 shows the column M standing in the region where the flat passage 10 and the stairway 11 intersect each other, as an example of the structure M standing in the region where multiple passages intersect one another. However, the structure M to which the mirror 1 is attached is not limited to a structure standing in such a location. For example, the mirror 1 can be also attached to a curved surface S of a structure M standing in a region where a stairway 11 and another stairway 11 intersect each other. Moreover, a passage in which the height of a passage surface sequentially changes in the up-down direction is not limited to the stairway 11, and an escalator can be given as an example.

Alternatively, as shown as an example in FIG. 9, the mirror 1 can be attached to a curved surface S of a structure M such as a column standing in a region where a flat passage 10 and another flat passage 10 intersect each other. The passers-by 9a, 9b cannot directly see each other due to a partition 8. Each of the passers-by 9a, 9b thus sees an image of the other passer-by appearing in the mirror 1 attached to the curved surface S of the column M located at the front of the partition 8. Each of the passers-by 9a, 9b can thus accurately grasp the situation of the other passer-by from an image with no feeling of strangeness in the aspect ratio and avoid collision with each other.

Examples of the structure M to which the mirror 1 is attached include column members, wall members, and the like which are in station buildings and station platforms of subways and railways, commercial facilities, public facilities, underground passages, and other buildings and which are at locations where blind spots of the passers-by 9a, 9b and the like are desired to be reduced. Moreover, the mirror 1 can be attached not only to the curved surface S of the column M but also to a curved surface S of a structure M having a semi-circular cross section or the like. The mirror 1 can be attached not only to the structure M provided indoor but also to the structure M provided outdoor.

In the present invention, for example, the radius of curvature Rm of the convex mirror which is set to provide the aggregate of the many strip reflective surfaces 5a with the cylindrical convex mirror function is set within a range of (1±0.5)×Rp, where Rp is the radius of curvature of the curved surface S of the structure M. Specifically, the radiuses of curvatures Rm and Rp of the convex mirrors which are set such that the convex mirror function is exerted in both of the direction transverse to the extension direction of the strip reflective surfaces 5a and the extension direction are set to be close to each other. For example, the radius of curvature Rm is changed to be set to a target value by adjusting the degree of each of the inclination angles A. Although the size of the radius of curvature Rp is not particularly limited, the size is about 100 mm to about 800 mm, or about 300 mm to about 600 mm for example.

When the radius of curvature Rm and the radius of curvature Rp are set to the same value and the aspect ratio of the image in the mirror 1 is set to 1:1, a situation in the blind spot can be grasped with almost no more feeling of strangeness than that in a case where the situation is actually viewed. When the radius of curvature Rm is set with respect to the radius of curvature Rp within a range of (1±0.5)×Rp, preferably within a range of (1±0.3)×Rp, more preferably within a range of (1±0.1)×Rp, the aspect ratio is within such a range that there is no feeling of strangeness, and recognition of the image in the mirror 1 is facilitated.

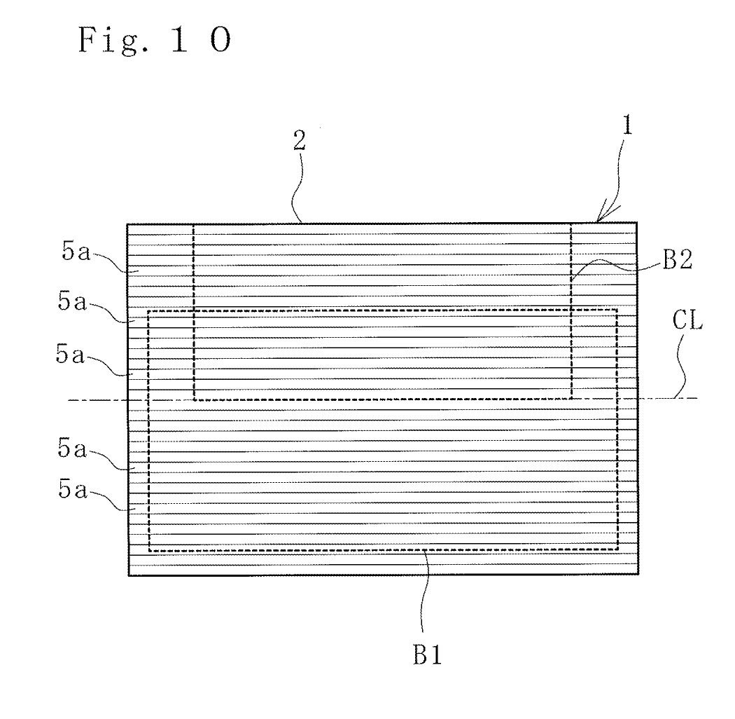

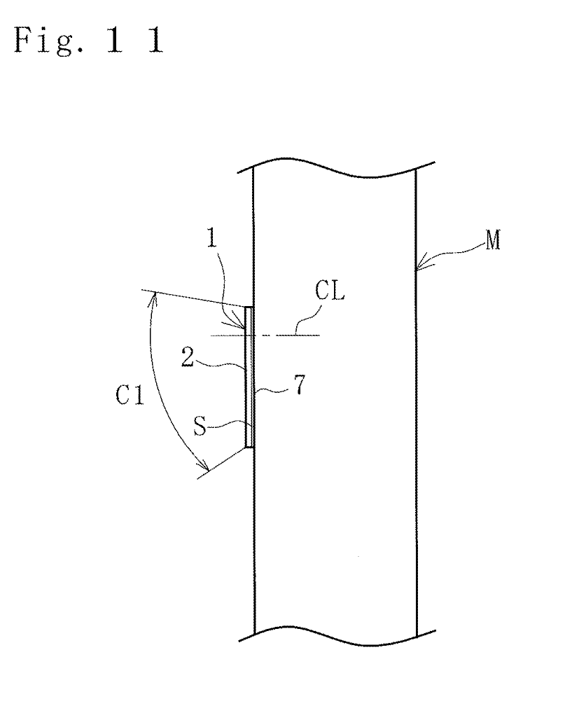

The present invention is not limited to a specification in which the inclination angle A is sequentially increased with an increase in the distance from the center portion of the sheet 2 in the directions toward both outer sides. For example, as in regions B1, B2 shown in FIG. 10 which are surrounded by broken lines, portions offset to one side in the direction transverse to the extension direction of the strip reflective surfaces 5a with respect to the center line CL of the sheet 2 can be employed.

In other words, the mirror 1 can be configured such that the inclination angle A formed between the width direction of each of the strip reflective surfaces 5a and the surface direction of the sheet 2 is sequentially changed with an increase in the distance in the direction transverse to the extension direction of the strip reflective surfaces 5a. In this configuration, the aforementioned field of view C1 of a wide angle which is obtained through the cylindrical convex mirror function can be obtained only in the direction transverse to the extension direction of the strip reflective surfaces 5a. Meanwhile, in the extension direction of the strip reflective surfaces 5a, the field of view C2 of a width angle is obtained through the convex mirror function obtained by bending the extension direction of the strip reflective surfaces 5a along the curved surface S. Accordingly, the feeling of strangeness in the aspect ratio of the image in the mirror 1 is reduced, and recognition of the image is facilitated.

For example, as shown in FIG. 11, when a portion offset to a lower side (one side in the direction transverse to the extension direction of the strip reflective surfaces 5a) with respect to the center line CL of the sheet 2 is used as the mirror 1, the range of the field of view C1 obtained through the cylindrical convex mirror function is a range offset to a lower side with respect to the center line CL. In the location illustrated in FIG. 6, the passers-by 9a, 9b normally do not need a range of field of view C1 offset to the upper side of the mirror 1. Accordingly, in such a location, the mirror 1 illustrated in FIG. 11 may be used. As described above, it is preferable to determine which region of the sheet 2 in the up-down direction with respect to the center line CL is to be used as the mirror 1, depending on the required range of the field of view C1.

### EXPLANATION OF REFERENCE NUMERALS

1 mirror for checking blind spot
2 sheet
3 transparent resin plate
4 inclined groove
5 reflective layer
5a strip reflective surface
6 coating layer
7 attachment member
8 partition
9a, 9b passer-by
10 flat passage
11 stairway
12 cylindrical convex mirror
A (A1, A2, A3, A4) inclination angle
M structure (column)
S curved surface

1. A mirror for checking a blind spot wherein
a large number of linearly-extending strip reflective surfaces are arranged in a surface of a sheet to be parallel and adjacent to one another,
an inclination angle formed between a width direction of each of the strip reflective surfaces and a surface direction of the sheet is sequentially changed with an increase in a distance in a direction transverse to an extension direction of the strip reflective surfaces,
an aggregate of the strip reflective surfaces has a cylindrical convex mirror function, and
the sheet is bendable in a cylindrical shape about an axis parallel to the direction transverse to the extension direction of the strip reflective surfaces.

2. The mirror for checking a blind spot according to claim 1, wherein the inclination angle is sequentially increased with an increase in a distance from a center portion of the sheet in directions toward both outer sides, respectively.

3. The mirror for checking a blind spot according to claim 1, wherein the sheet is attached to a curved surface of a structure with the extension direction of the strip reflective surfaces aligned with a circumferential direction of the curved surface, the structure standing in a region where a plurality of passages intersect each other in such a relationship that passers-by passing through the respective passages are blind to each other.

4. The mirror for checking a blind spot according to claim 3, wherein the plurality of passages include a passage in which a height of a passage surface sequentially changes in an up-down direction and a passage which extends such that a height of a passage surface is the same in a horizontal direction.

5. The mirror for checking a blind spot according to claim 4, wherein
the passage in which the height of the passage surface sequentially changes in the up-down direction is a stairway or an escalator, and
the passage which extends such that a height of a passage surface is the same in a horizontal direction is a platform of a railway station.

6. The mirror for checking a blind spot according to claim 1, wherein
the sheet is formed such that a large number of the strip reflective surfaces are formed on a back surface of a transparent resin plate and a coating layer is laminated on the strip reflective surfaces, and
the thickness of the sheet is 0.1 mm to 2.0 mm.

7. The mirror for checking a blind spot according to claim 3, wherein a radius of curvature Rm set to provide the mirror with the convex mirror function is set within a range of (1±0.5)×Rp, where Rp is a radius of curvature of the curved surface of the structure.

8. The mirror for checking a blind spot according to claim 4, wherein a radius of curvature Rm set to provide the mirror with the convex mirror function is set within a range of (1±0.5)×Rp, where Rp is a radius of curvature of the curved surface of the structure.

9. The mirror for checking a blind spot according to claim 5, wherein a radius of curvature Rm set to provide the mirror with the convex mirror function is set within a range of (1±0.5)×Rp, where Rp is a radius of curvature of the curved surface of the structure.
